(19) United States
(12) Patent Application Publication
(10) Pub. No.: US 2019/0186418 A1
(43) Pub. Date: Jun. 20, 2019

(54) Multi-Hybrid Aircraft Engine

(71) Applicant: Bingham Robert A., Oakley, UT (US)

(72) Inventor: Orlorunfemi Jacob Azundah, Emohua (NG)

(21) Appl. No.: 16/326,717

(22) PCT Filed: Aug. 28, 2017
(86) PCT No.: PCT/US2017/048816

§ 371 Date: Feb. 20, 2019

Related U.S. Application Data
(60) Provisional application No. 62/380,703, filed on Aug. 29, 2016.

(51) Int. Cl. F02K 5/00; B64D 27/24; B64D 27/16

(52) U.S. Cl. CPC F02K 5/00; F02C 7/36; B64D 27/16; B64D 27/24

(57) ABSTRACT

A multi-hybrid aircraft engine that includes a primary compressor 1, a multiplier 199 comprising a drive block, a driven block, driven block pistons 54, and primary shafts 78 and 41; an output shaft 105, and a speed regulator 167. The multi-hybrid aircraft engine is configured such that the primary compressor 1 is fluidly connected to the drive block 46 which is mechanically connected to the driven block 57. The primary compressor 1 pumps compressible fluid to the drive block 46 through the speed regulator 167 to drive the drive block 46, which in turn, drives the primary shafts 78 and 41. The primary shafts 78 and 41 drive the driven block 57, which pumps fluid via the driven block pistons 54, to the drive block 46 through the speed regulator 167 to increase the flow rate of compressible fluid within the multi-hybrid aircraft engine. Furthermore, the driven block 57 provides a shaft 68 that is connected to sets of planetary gears 62 connected to an output shaft 105 that drives a propeller 186.

### RELATED APPLICATIONS

This application claims the benefit of U.S. Provisional Application No. 62/380,703 filed Aug. 29, 2016, which is herein incorporated by reference.

### TECHNICAL FIELD

The present disclosure relates generally to the field of aircraft engines and, in particular, to a hybrid aircraft engines powered by an external power source such as combustion engine, an electric motor, a compressed air, and/or man power.

### BACKGROUND OF THE INVENTION

The disclosure set forth herein relates to an arrangement comprising a speed regulator, a primary compressor and a multiplier comprising a rotatable drive block, a rotatable driven block, a swash plate, and driven block pistons in which; the primary compressor, when driven by an external power source compresses air to the multiplier through the speed regulator. The compressed air when allowed to flow through the multiplier drives the rotatable drive block that is mechanically connected to the rotatable driven block configured for pumping compressible fluid to the speed regulator via the swash plate and the driven block pistons. The compressible fluid, when pumped by the driven block pistons merges with the compressible fluid pump by the primary compressor resulting in an increase of fluid flow through the rotatable drive block of the multiplier. The multiplier further comprises one or more sets of planetary gears and a front fan that are mechanically in connection with one or more shafts that drive the driven block.

The configuration of the multi-hybrid aircraft engine comprises an integration of turbojet engines. In other words, one or more components of the multi-hybrid aircraft engine may be integrated to work with one or more components of turbojet engines and/or turbojet engines may be configured using the working principle of the multi-hybrid aircraft engine.

One or more components of the multi-hybrid aircraft engine may be configured to function as a compressor and/or motor for driving an external device.

Most conventional hybrid aircraft engines, particularly, those powered by electric motors that are driven by one or more batteries that are charged by an internal combustion engine, involve far less thrust, which is the reason electric planes tend to be slow. Electrical powered planes are generally slow, which is why it is challenging to fly hundreds of passengers at a time.

One of the biggest challenges of electrical powered planes is battery technology, specifically a battery's specific energy, or the limited amount of energy it can store for a given amount of weight. This limitation greatly poses challenging complications in the use of one or more electric motors for powering a plane.

### SUMMARY OF THE INVENTION

With the present invention, it is intended to create an aircraft engine that overcomes the shortcomings of known arts, such as those mentioned above.

The disclosure set forth herein relates to an arrangement comprising a speed regulator, a primary compressor and a multiplier, in which the primary compressor, when driven by an external power source may pump compressible fluid from the primary compressor to the speed regulator through the primary compressor outlet for delivering compressible fluid to the multiplier. The primary compressor comprises a swash plate that may be used to translate the motion of a rotating shaft into reciprocating motion of one or more compressor pistons.

The speed regulator comprises a plurality of inlets/outlets and one or more moveable parts. The speed regulator includes two moveable parts that are configured to move back and forth within chambers in the speed regulator. The speed regulator may be configured to receive fluid from the primary compressor and the multiplier and delivers the fluid to the multiplier.

The multiplier comprises a drive block, one or more drive block pistons, a swash plate, a driven block, one or more driven block pistons, and primary shafts. The drive block may be configured to receive compressible fluid from the speed regulator and translate the energy provided by the flow of the compressible fluid to rotational energy of the drive block via the swash plate. The primary shafts may be connected to the drive block and the driven block for transferring the rotational energy of the drive block to the driven block for compressing of compressible fluid to the speed regulator.

The utility of the multi-hybrid aircraft engine may be based, at least in part, on the size differences of the compressor pistons, the drive block pistons, and the driven block pistons. In some embodiments, the drive block pistons are larger (e.g., wider in diameter) than the compressor pistons, which are larger than the driven block pistons. Because the compressor pistons are smaller than the drive block pistons, the input torque required to drive the primary compressor may be relatively low. Further, due to the relatively large size of the drive block pistons relative to the driven block pistons, the drive block may produce a relatively large drive force relative to the drive force of the driven block. The differences in size between the compressor pistons, the drive block pistons, and the driven block pistons may provide advantages resulting from the application of Pascal's principle. These advantages and the configuration of the multi-hybrid aircraft engine make it possible for a single primary compressor to drive one or more multipliers with very little input torque and speeds. Moreover, the size differences between the compressor pistons, the driven block pistons, the drive block pistons, and the configuration may depend on design requirements.

Accordingly, a multi-hybrid aircraft engine is provided comprising a primary compressor, a speed regulator, a multiplier comprising a drive block, one or more drive block pistons, a swash plate, a driven block, one or more valves, one or more driven block pistons; a gearbox, front fan, and a housing in which the multiplier and the gearbox are housed.

The primary compressor may be driven by means of an external power source (e.g., an electric motor, an internal combustion engine, or man power) for pumping compressed air into the speed regulator for proper control of the compressed air though the drive block. The compressed air from the speed regulator received by the drive block may drive one or more drive block pistons to convert their translational motion to a rotational motion via the swash plate. The rotation of the drive block pistons results in the rotation of the drive block. The primary shafts may be connected to the drive block and the driven block for transferring of rotational energy of the drive block to the driven block thus, allowing the driven block to be driven by the drive block.

The rotating driven block may drive one or more driven block pistons that are designed to translate within chambers of the driven block as they are carried around on piston tracks of the swash plate. The translating pistons draw compressible fluid from inlet passages of the valves into the driven block, compress the compressible fluid and discharge it to the speed regulator. The compressed air from the driven block merges with the compressed air from the primary compressor, thereby, increasing the flow of compressed air through the drive block. The increased flow of compressed air through the drive block further increases the rotational energy of the drive block over time.

In accordance with another aspect of the invention, a multi-hybrid aircraft engine is provided comprising a compressed air tank containing compressed air, a speed regulator, a multiplier comprising a drive block, one or more drive block pistons, a swash plate, a driven block, one or more driven block pistons; a gearbox, and a housing in which the multiplier and the gearbox are housed.

The compressed air from the compressed air tank may be allowed to flow through the speed regulator and then to the drive block to drive the drive block pistons so that the motion of the drive block pistons causes the drive block to be rotated. The rotational energy of the drive block may be transferred to the driven block via the primary shafts connected to the drive block and driven block to allow the driven block to drive the driven block pistons. The driven block pistons are coupled to the swash plate configured to convert the rotational motion of the driven block pistons to translational motion, thus, permitting the driven block pistons to slide in and out of chambers within the driven block.

The multiplier further comprises a set of insertable seals and valves with inlet and outlet passages for receiving and ejecting compressible fluid. The set of insertable seals are designed to permit the flow of both compressible and non-compressible fluid through desired passages of the valves and the driven block/drive block and also for preventing the mixing of compressible fluid with non-compressible fluid.

In accordance with still another aspect of the invention, a multi-hybrid aircraft engine is provided in which an aircraft runs on compressed air and an internal combustion engine, wherein the compressed air drives the multiplier. At lower pressures of compressed air in the compressed air tank the internal combustion engine may be engaged to drive a primary compressor, providing pressure to drive a drive block that drives a driven block via primary shafts. Compressed air leaving the drive block may be directed and stored in the compressed air tank. At higher pressure the internal combustion engine may be disengaged, allowing the aircraft to run on compressed air.

In accordance with another aspect of the invention, a multi-hybrid aircraft engine is provided wherein the primary compressor and the multiplier serve as a compressor and/or a compressor motor for providing compressed air to a conventional aircraft or other sources and/or for driving external devices.

According to another aspect of the invention, a multi-hybrid aircraft engine is provided comprising a primary compressor, a speed regulator, a multiplier comprising a drive block and a driven block, a gearbox, an axial compressor, set of planetary gears, an output shaft, a front fan, and a combustion chamber. The front fan, the gearbox, the driven block, the drive block, the set of planetary gears, and the axial compressor are connected to the output shafts so that they are driven by the output shafts. The multiplier seats in between the gearbox that drives the front fan and the axial compressor so that the driven block of the multiplier drives one or more sets of planetary gears in the gearbox and the drive block of the multiplier drives the axial compressor. When in operation, compressed air from the primary compressor drives the drive block by passing through the speed regulator and the motion of the drive block drives the output shaft that is connected to the axial compressor thereby, causing compressed air to enter the combustion chamber where it combusts with fuel for additional thrust. Some compressed air from the axial compressor may bypass the combustion chamber and be used for afterburner effect. The multi-hybrid aircraft engine of the present invention has no turbine. Thus, all energy produced by the combustion is used as thrust.

The output shafts driven by the drive block drives the driven block to provide the drive block an increase of speed as compressed air from the driven block merges with the compressed air from the primary compressor. The increased rotational speed of the drive block results in an increased rotational speed of the output shafts that drive the front fan and the axial compressor.

Furthermore, a multi-hybrid aircraft engine herein referred to as a multi-hybrid turbojet engine is provided comprising a primary compressor, a secondary compressor, a turbine, an output shaft, a compression chamber, sets of planetary gears, a combustion compressor, and a combustion chamber. The secondary compressor and the turbine are displaced within an inner casing set within another casing linking to the combustion compressor. The compression chamber is positioned between the secondary compressor and the turbine with the inner casing forming an enclosure that is intended to cause compressed air from the primary compressor to escape the compression chamber through the turbine. The primary compressor may be positioned in any location within the aircraft and may be powered by an external power source to compress compressible fluid into the compression chamber. The compressible fluid when compressed into the compression chamber drives the turbine to power the output shaft that is connected to the secondary compressor and the sets of planetary gears that drive the combustion compressor. The combustion compressor when in motion compresses air to the combustion chamber for combustion and provides an extra boost to the multi-hybrid turbojet engine.

The advantages of multi-hybrid aircraft engines and multi-hybrid turbojet engines include a higher fuel efficiency and extended battery life that results from configurations that provide torques and speeds multiplications. In other words, conversely to conventional configurations that include a drive system in which an electric motor and/or an internal combustion engine is/are coupled directly to the propeller, the present disclosure provides a drive system in which the electric motor and/or the internal combustion engine drive a compressor (primary compressor) that compresses air to another unit of the engine so that torque and speeds are multiplied creating more thrust than known hybrid aircraft engines. In addition, a multi-hybrid aircraft engines/multi-hybrid turbojet engines can efficiently run on compressed air.

### BRIEF DESCRIPTION OF THE DRAWINGS

The written disclosure herein describes illustrative embodiments that are nonlimiting and non-exhaustive. Reference is made to certain of such illustrative embodiments that are depicted in the figures, in which:

FIG. 1 is a perspective view of a primary compressor of a multi-hybrid aircraft engine.

FIG. 2 is a cross-sectional view taken along the line 2-2 in FIG. 1.

FIG. 3 is a perspective view of a cartridge block, a separator, and components of valves of the primary compressor of FIG. 2.

FIG. 4 is an exploded view of components of the valves of FIG. 3.

FIG. 5 is a perspective exploded view of addition components of the valve and a cartridge of FIG. 3.

FIG. 6 is a perspective view of a half cut cartridge block of FIG. 2.

FIG. 7 is a perspective view of a half cut power shaft, a half cut swash plate, and compressor pistons of FIG. 2.

FIG. 8 is a perspective view of a swash plate of FIG. 2.

FIG. 9 is a perspective view of a swash plate retainer of FIG. 2.

FIG. 10 is a front view of a speed regulator.

FIG. 11 is a cross-sectional view taken along the line 11-11 in FIG. 10.

FIG. 12 is an exploded perspective view of the speed regulation of FIG. 10.

FIG. 13 is a perspective view of a multi-hybrid aircraft engine.

FIG. 14 is a perspective view of connectors and a third housing of the multi-hybrid aircraft engine of FIG. 13.

FIG. 15 is a perspective view of a half cut third housing of FIG. 14.

FIG. 16 is an isometric view of housings of the multi-hybrid aircraft engine of FIG. 13.

FIG. 17 is a side view of the multi-hybrid aircraft engine of FIG. 13, with the casings omitted.

FIG. 18 is a top view of the multi-hybrid aircraft engine of FIG. 13, with the casings omitted.

FIG. 19 is a cross-sectional view taken along the line 19-19 in FIG. 18 and rotated 180 degree.

FIG. 20 is a perspective view showing the order of arrangement of a block retainer, a drive block, a set of seal, a valve retainer, and a drive block valve of the multi-hybrid aircraft engine of FIG. 13.

FIG. 21 is a perspective view of the block retainer of FIG. 20.

FIG. 22 is a perspective view of the drive block of FIG. 20.

FIG. 23 is a perspective view of the set of seal of FIG. 20.

FIG. 24 is a perspective view of the valve retainer of FIG. 20.

FIG. 25 is a perspective view of the drive block valve of FIG. 20.

FIG. 26 is a perspective view showing the order of arrangement of a driven block valve, a valve retainer, a set of seal, a driven block, and a driven block retainer of the multi-hybrid aircraft engine of FIG. 13.

FIG. 27 is a perspective view of the driven block valve of FIG. 26.

FIG. 28 is a perspective view of the valve retainer of FIG. 26.

FIG. 29 is a perspective view of the set of seal of FIG. 26.

FIG. 30 is a perspective view of the driven block of FIG. 26.

FIG. 31 is a perspective view of the block retainer of FIG. 26.

FIG. 32 is a front view of the set of seal, the valve retainer, and the drive block valve of FIG. 20.

FIG. 33 is a perspective view of the drive block valve of FIG. 32.

FIG. 34 is a front view of the valve retainer of FIG. 32.

FIG. 35 is a front view of the inner seal of the set of seal of FIG. 32.

FIG. 36 is a front view of the outer seal of the set of seal of FIG. 32.

FIG. 37 is a side view showing a connection of the drive block, a set of seal, and valve retainer of FIG. 20.

FIG. 38 is a cross-sectional view taken along the line 38-38 in FIG. 37.

FIG. 39 is a front view of a connection of a fifth housing and a swash plate of the multi-hybrid aircraft engine of FIG. 13.

FIG. 40 is a cross-sectional view taken along the line 40-40 in FIG. 39.

FIG. 41 is a perspective view of the fifth housing, the swash plate, a drive piston, and a driven piston of FIG. 40.

FIG. 42 is a schematic diagram illustrating the working principle of the multi-hybrid aircraft engine.

FIG. 43 is a schematic diagram illustrating the working principle of the multi-hybrid aircraft engine components configured to function as a compressor and/or a drive system.

FIG. 44 is a schematic diagram showing an integration of multi-hybrid aircraft engine with turbojet engine.

FIG. 45 is a perspective view of a modified valve retainer of the multi-hybrid aircraft engine of FIG. 13.

FIG. 46 is another perspective view of the valve retainer of FIG. 45.

FIG. 47 is a perspective view of an alternative seal of the multi-hybrid aircraft engine of FIG. 13.

FIG. 48 is another perspective view of the seal of FIG. 47.

FIG. 49 is a perspective view of a modified drive block of the multi-hybrid aircraft engine of FIG. 13.

FIG. 50 is a schematic diagram illustrating a configuration of turbojet components in which the working principle of the multi-hybrid aircraft engine of FIG. 44 is applied.

### DETAILED DESCRIPTION OF THE PREFERRED EMBODIMENTS

The multi-hybrid aircraft engine above is described in further detail below in connection with exemplary embodiments of the invention depicted in the accompanying drawings.

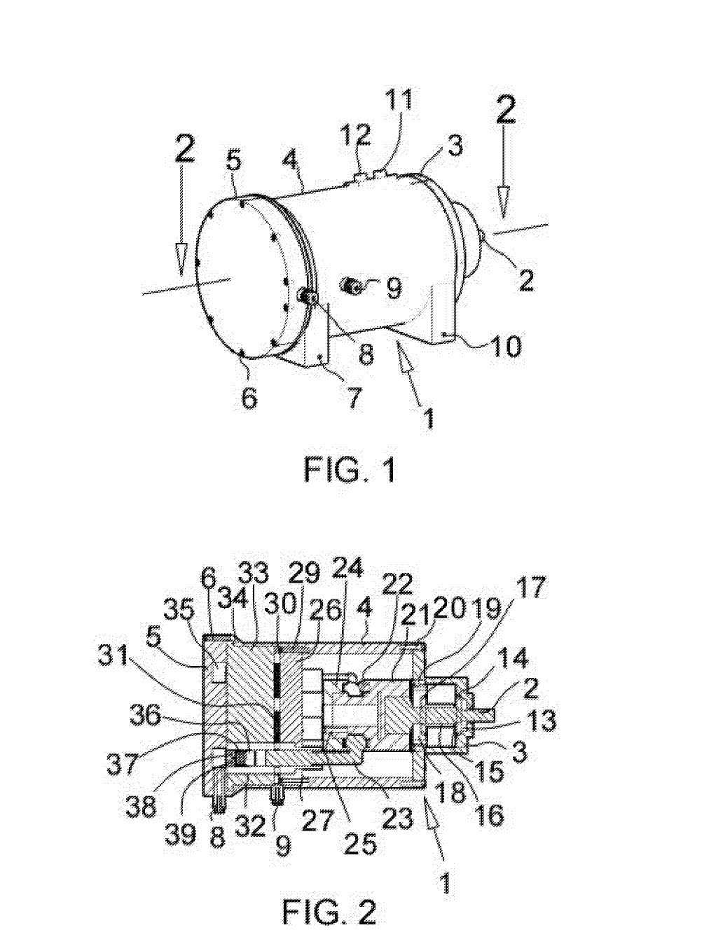

The primary compressor 1 as shown in FIGS. 1-9 has a power shaft 2 extending though a bearing support 18, a tapered roller bearing 14 and 17, a hallow rod 16, and a snap ring 15. The power shaft 2 may also go through an oil seal 13 seated in a front covering 3 that is coupled to a compressor housing 4 with bolts 20. The bearing support 18 may be connected to the front covering 3 and held together with bolts 19. The hallow rod 16 ensures that the tapered roller bearings 14 and 17 maintain their positions and the snap ring 15 may prevent the power shaft 2 from moving back and forth. The power shaft 2 may be coupled to a swash plate 21 with bolt 131 as shown in FIG. 8. The swash plate 21 has tracks 22 and 130, see FIG. 7, for mounting compressor pistons 23, and a swash plate retainer 24 coupled to swash plate 21 with bolts 25. The coupling of swash plate retainer 24 to the swash plate 21 may provide a support and track 130 for the compressor pistons 23 so that they experience translational motions while in their cartridges 32. The bolts 25 pass through holes 133 and engage threaded holes 132 of the swash plate 21.

With hydraulic seals fixed at the other end of compressor pistons 23, the compressor pistons 23 may be inserted into their cartridges 32. (Because the primary compressor 1 may be designed to run as low as one revolution per second throughout the operation time, a hydraulic sealing system may be the most suitable, for maximum compression at low speed. However, other sealing system e.g., compression rings, may be used). Each of the cartridges 32 may have a valve housing 117. A space 36 is provided inside each cartridge 32 so that the compressor pistons 23 do not touch the valve housing 117. This space 36 also permits easy movement of the compressor pistons 23. Each of the valve housings 117 may have an inlet valve 121 and an outlet valve 120. The inlet valves 121 may be inserted into the valve housings 117 from the right side of the view, as shown in FIG. 4, so that the large end part of it may lap in the valve housing 117 to seal it up when the inlet valve 121 is in closed position or when the compressor pistons 23 start moving toward the valve housing 117. A spring 122 may be inserted into the valve housing 117 for returning the inlet valve 121 to a closed state once the compressor pistons 23 start moving toward the valve housing 117.

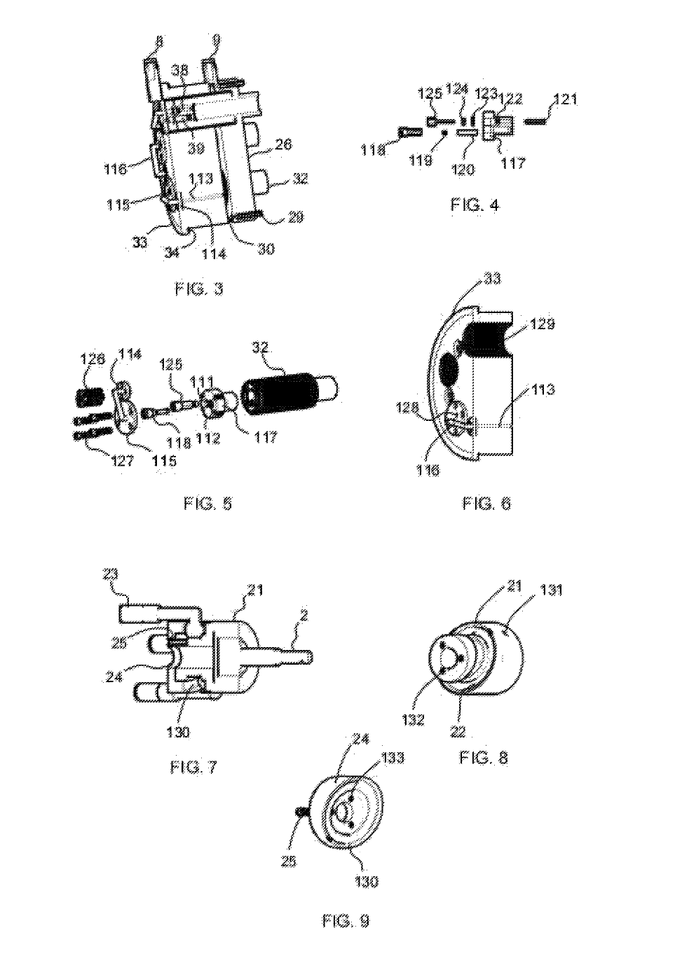

A spring support 123 and a lock 124 (bolt) may be connected to the inlet valve 121. The lock 124 may prevent the inlet valve 121 from moving completely away from the valve housing 117 when a vacuum is created as the compressor pistons move away from the valve housing 117. The springs 122 may provide a proper sealing of inlet valves 121. The inlet valves 121 are hallow but not all through. This allow valve supports 125 to go through the inlet valves 121 to restrict undesirable movements of the inlet valves 121 as they move in and out of valve housings 36. The locks 124, the spring supports 123 and the inlet valves 121 slide in chambers 38, as can be seen in FIG. 3. Outlet valves 120 may rest in a valve supports 118 with springs 119 placed between them. The outlet valves 120, the springs 119, and the valve supports 118 may be rest in the outlet chambers 39. The outlet valves 120 may be designed to allow compressible fluid in the cartridges 32 to flow through an exit passage 35 of a back covering 5, see FIG. 2, and then leave the compressor through an outlet(s) 8. With the inlet valves 121 and their supporting components, the locks 124, the spring supports 123, the springs 122, and the valve supports 125 in their chambers 38 and the outlet valves 120 and their supporting components, the springs 119, and valve supports 118 in their chambers 39, valve housings 117 with threaded part 37 may be fastened to their cartridges 32 and may be supported with valve caps 115 and bolts 127. The valve supports 125 may be inserted into the valve housings 117 through a hole 111 and the valve supports 118 may be inserted into the valve housings 117 through a hole 112. The cartridges 32 may be fastened to a cartridge block 33 and a separator 26 that may be mounted in compressor housing 4. The cartridges 32 have threaded parts 31 that mate with cartridge block threaded parts 129 and the separator 26. A seal 27 may be placed between the separator 26 and the compressor housing 4 and held together with bolts 29. A seal 34 may be placed between the cartridge block 33 and the compressor housing 4, with a back covering 5 connected to the cartridge block 33 and both coupled to the compressor housing 4 with bolts 6. The cartridge block 33 and the separator 26 may have a space between them. The space between them is an air chamber 30 through which compressible fluid entering the air chamber 30 through inlet 9 may travel through air passages 113, a connecting port 114 held to the cartridge block 33 with bolts 126, and a pipe 116 and head for the inlet chambers 38 of the valve housing 117 where the inlet valves 121 and their supporting components are located. Once compressible fluid enters the cartridges 32 through the inlet chambers 38, it may be compressed by the compressor pistons 23 to leave the cartridges through the outlet chambers 39, where the outlet valves 120 and their supporting components are located, to be discharged to the back covering through a hole 128 as shown in FIG. 6. The back covering 5 may have one or more outlets 8 through which compressible fluid may leave the primary compressor 1 and head for the speed regulator (or speed regulators, in the case where a single primary compressor 1 is designed to power more than one multipliers). The compressor housing 4 has two stands with threaded openings 7 and 10 for mounting the primary compressor at a fixed position. The primary compressor also has an inlet 12 for receiving lubricant and an outlet 11 for delivering of lubricant to a multiplier.

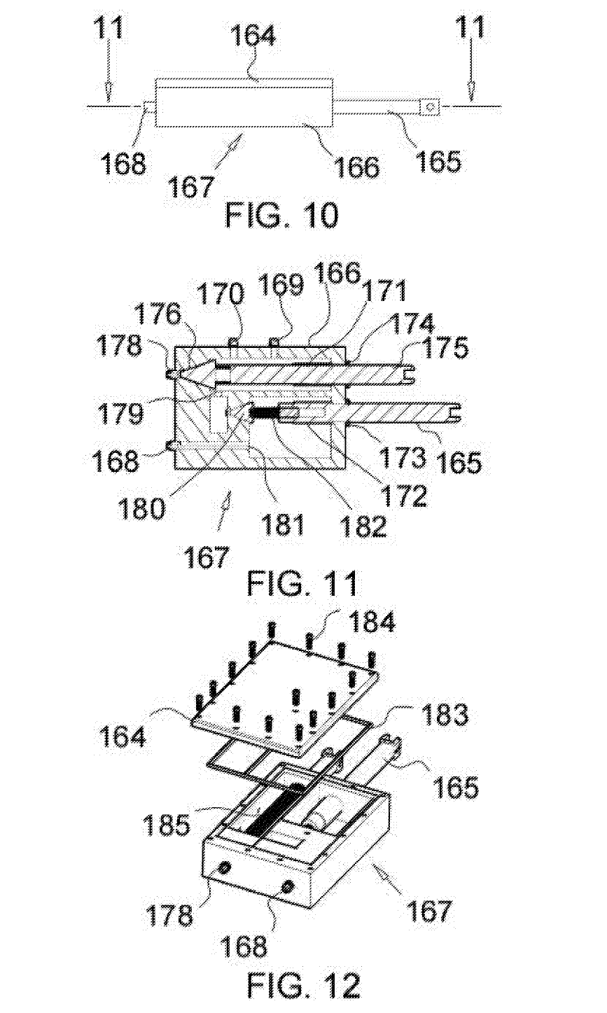

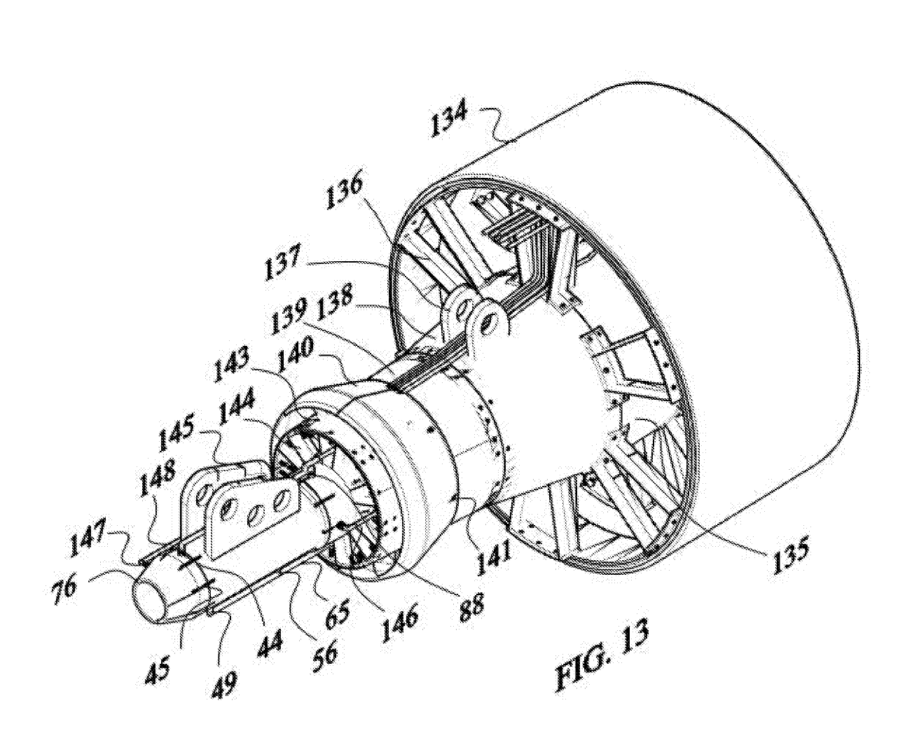

As can be seen in FIGS. 10-12, the speed regulator 167 comprises a housing 166, a covering 164, and a seal 183 that may be placed between the housing 166 and the covering 164 and all held together with bolts 184. Compressible fluid from the primary compressor may flow into the speed regulator 167 through inlet 169 to a first region comprising a control valve 176, a spring 185, a seal 171, a piston 175 and a cap 174 that may be fastened to the housing 166. The seal 171 may be placed in the piston chamber and the piston 175 inserted into its chamber. The control valve 176 may be inserted into the housing and spring 185 may be placed between the housing wall and the control valve 176 so that when the piston 175 is fastened to control valve 176, one end of the spring 185 may rest on the control valve 176 and the other end rest on the housing wall. The control valve 176 may be opened by pulling the piston 175 away from the speed regulator 167. Once the control valve 176 is opened, compressible fluid flowing into the speed regulator 167 may pass through outlet 178 to head for the multiplier. At higher pressure, some fluid may pass through a fluid passage 179 to enter a second region which comprises a bypass valve 180, a spring 182, a seal 172, a cap 173, and a piston 165. The bypass valve 180 may go through the spring 182 and about half way through the piston 165. The bypass valve 180 may be positioned in a fluid passage to control the flow of pressurized fluid from the first region. The seal 172 may be mounted in a piston chamber and the piston 165 inserted into its chamber for controlling pressurized fluid. The bypass valve 180 which is placed in the piston 165 enables one end of the spring 182 to seat on the bypass valve 180 and the other end to seat on the piston 165. In this way compressible fluid entering the second region may have to compress the spring 182 by pushing the bypass valve 180 toward the piston 165. Compressible fluid in the second region may leave the region through a passage 181 and an outlet 168 to be discharged to the surrounding.

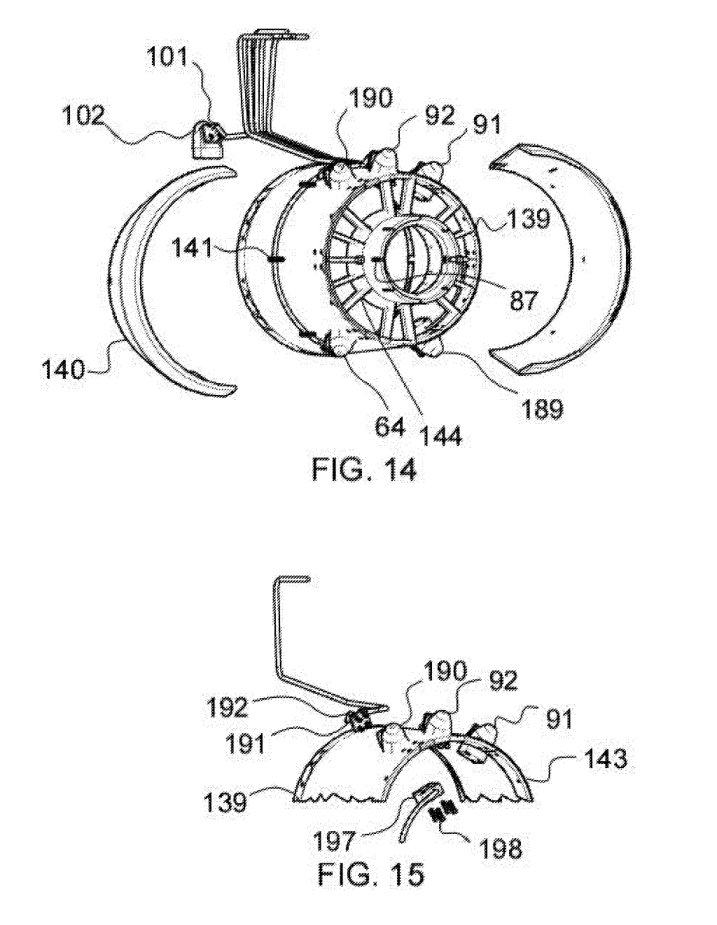

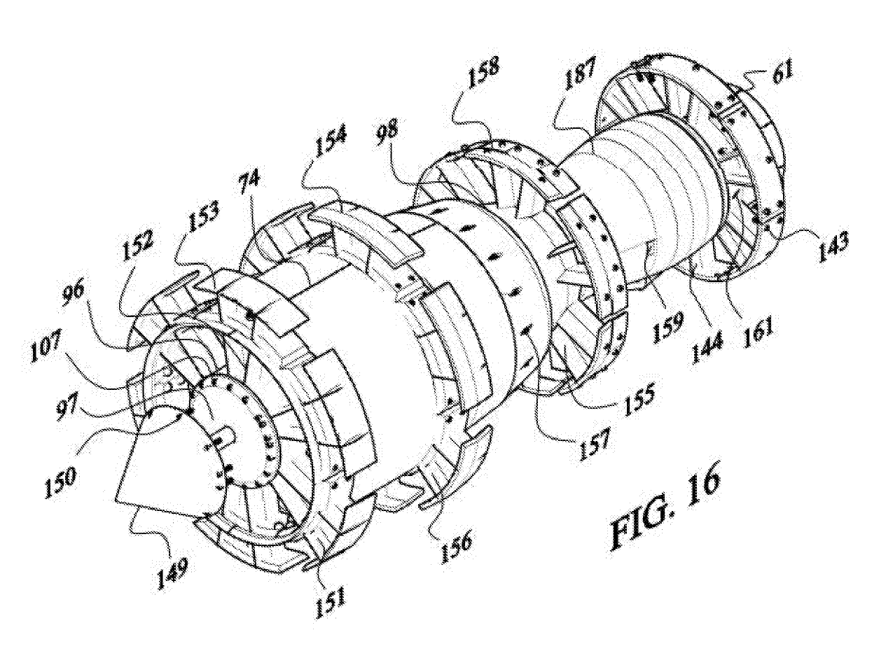

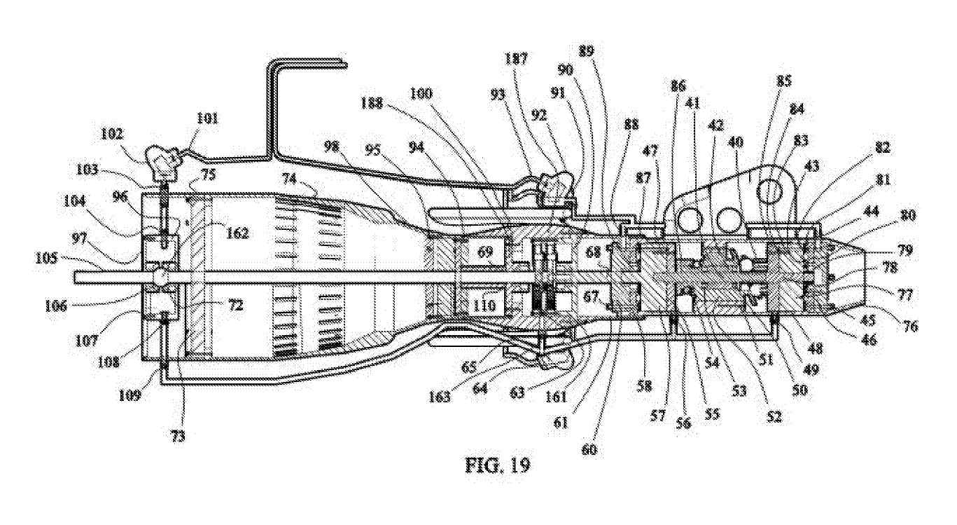

FIGS. 13-19, provides a multi-hybrid aircraft engine main body comprising a plurality of housings 74, 98, 187, 61, and 48, and a plurality of coverings, 97, 69, 188, and 90. As can be seen in FIG. 19, the first covering 97 may be attached to a bearing chamber 96 with bolts 107. A seal may be placed between the first covering 97 and the bearing chamber 96. The bearing chamber 96 may have casing supports 152 attached to it, see FIG. 16. The casing supports 152 attached to the bearing chamber 96 may be welded or connected to the first housing 74 and held together with bolts. Casing supports 153 may be attached to the first housing 74 and the opposite ends coupled to an inner casing 135 with bolts, see FIG. 13. The inner first casing 135 may have casing supports 136 for holding the upper casing 134 (front fan case). An inner second casing 138 having handles 137 for suspending the engine may be connected to the inner first casing 135.

As can be seen in FIGS. 16-19, the first housing 74 may be connected to the second housing 98 and held together with bolts 157. The first housing 74 may have casing supports 153 welded to stands 151 and another casing supports 154 welded to stands 156 and the stands 151 and 156 attached to the first housing 74. The second housing 98 may have an outlet 196 and casing supports 158 coupled to casing stands 155 and the stands 155 attached to it. The second housing 98 may be connected to the second covering 188 and held together with bolts 95. The third covering 69 may be coupled to the second covering 188 with bolts 94. A seal 110 may be placed between the third covering 69 and the second covering 188. The second covering 188 may be inserted into the third housing 187 and held together with bolts 100. The third housing 187 is a gearbox which comprises one or more sets of planetary gears 63, bearings, and oil seals. Each bearing and oil seal is mounted in second covering 188 and a fourth covering 90. The fourth covering 90 may be placed between the third housing 187 and the fourth housing 61 and coupled together with bolts 161. As shown in FIG. 16, the forth housing 61 may have an air inlet 146 and casing supports 144 attached to it and held in place with bolts 143.

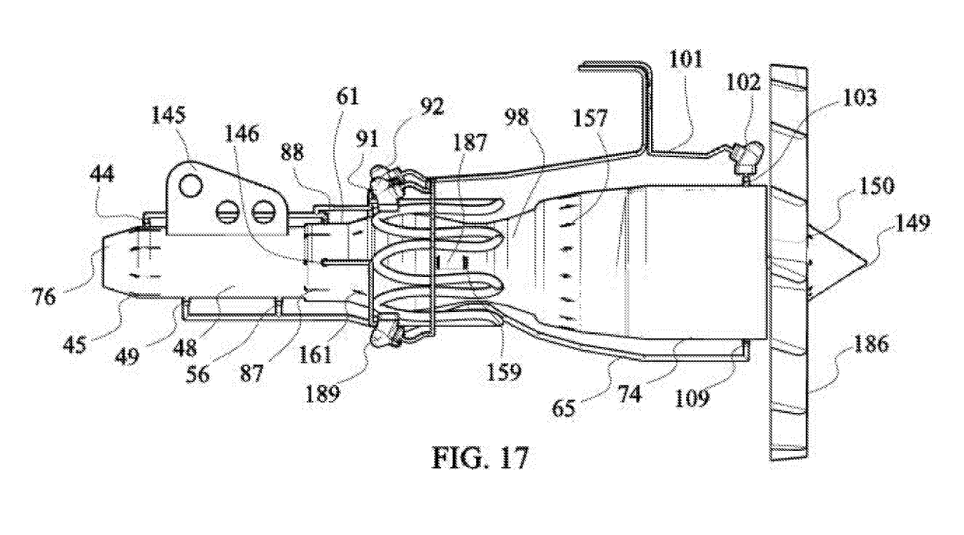

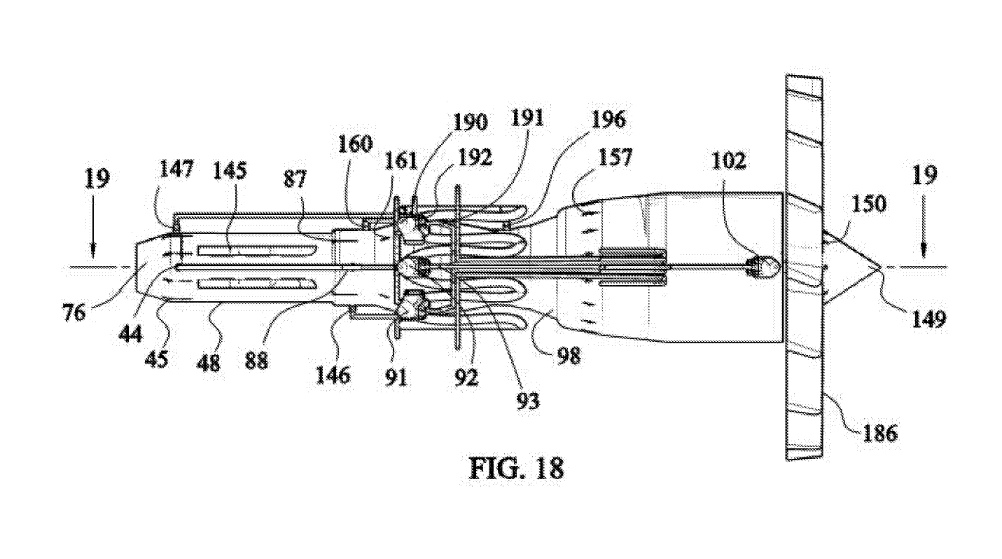

As can be seen in FIGS. 13-15, shields 140 may be connected to casing 139 with bolts 141. The casing 139 may have a plurality of connector(s) 190, 92, 91, 64, and 189, attached to it. Each of the connectors may allow incoming or outgoing compressible or noncompressible fluid to pass through it. For example, a hose/pipe 191 from an air chamber and its support may be connected to connector 190 with bolts 192 and with another hose/pipe 197 from air inlet 146 and its support may be connected below it (connector 190) with bolts 198. This allows fluid to travel from an air chamber to air inlet 146 through connector 190. This is the case for connectors 92, 91, 64, and 189. For example, as shown in FIG. 18, lubricant may pass through a pipe 93 and through connector 92 to flow into the multiplier through inlets 88 and 44. The connectors may be protected with shields 140 that may be coupled to casing 139 with bolts 141. As depicted in FIGS. 16-17, the fourth housing 61 may be connected to a fifth housing 48 and held together with bolts 87 and a nozzle 76 coupled at the opposite side of the fifth housing 48 with bolts 45. The fifth housing 48 provides handles 145 for hanging the machine in its place.

In connection with the above disclosure, when the speed regulator control valve 176 is in the open state, compressible fluid leaves the speed regulator through outlet 178 to the drive block valve 46 through a pipe 184 and an inlet 147. As shown in FIG. 19, the compressible fluid may flow through an inlet passage to the drive block 77. The energy of the compressible fluid entering the drive block 77 may cause the drive block pistons 40 to shoot out of the drive block 77. An inclined surface of a swash plate 52 converts the translational motion of the drive block pistons 40 to a rotational motion which may result in the rotation of the drive block 77. The rotation of the drive block 77 and the drive block pistons 40 may cause compressible fluid entering the drive block 77 from inlet passage to leave the drive block 77 to the drive block valve 46 through outlet passage and discharged to the surrounding through the nozzle 76.

A first primary shaft 78 may be meshed to the drive block 77 with a second primary shaft 41 inserted in the other end of the first primary shaft 78. The other end of the second primary shaft 41 may be splined to a driven block 57 so that the drive block 77 drives the driven block 57. Both the first primary shaft 78 and the second primary shaft 41 may go through a swash plate 52 mounted inside the wall of the fifth housing 48 with bolts 51. The swash plate 52 houses an M-bearing chamber 42 with openings 53 and 50 at each end for ball bearings to seat in. When a ball bearing is mounted in the swash plate 52 and the M-bearing chamber 42 is inserted into the swash plate 52, the swash plate 52 provides a support for the bearing in the swash plate 52 and the other end of the M-bearing chamber 42 is locked with a support or snap ring that seats in the swash plate 52. The support or snap ring prevents a ball bearing from falling off from its chamber 50 while the primary shafts 78 and 41 rotate and share the load on the rotating drive block 77 and the rotating driven block 57.

In this way the rotating drive block 77 drives the primary shafts 78 and 41 which are connected to it and the motion of the drive block 77 may drive the driven block 57. As the driven block 57 rotates, the driven block pistons 54 which are inserted into the driven block 57 are caused to translate as they move on a track on the swash plate 52 while in rotational motion with the driven block 57. The rotational and translational motion of the driven block pistons 54 may cause compressible fluid to enter the driven block valve 60 air inlet 146 and then to the driven block 57. The compressible fluid entering the driven block 57 goes in from an inlet passage and leaves through an outlet passage that leads it to the speed regulator from driven block valve outlet 160 through speed regulator inlet 170. The compressible fluid entering the speed regulator through inlet 170 may flow through a cooling system where the temperature of the compressible fluid is reduced. The compressible fluid entering the speed regulator may merge with the compressible fluid entering the speed regulator from the primary compressor 1 through speed regulator inlet 169 and head for the drive block 77. In this manner, compressible fluid pumped by the driven block 57 may be delivered to the drive block 77, thereby increasing fluid flow through the drive block 77. The process described above may be repeated any number of times. Over time, the amount of fluid from the driven block 46 that merges with fluid pumped by the primary compressor 1 may increase. This, in turn, may increase the flow rate of compressible fluid through the drive block 77, thereby increasing the rotational speed of the drive block 77. This increased speed may increase the rotational speed of the primary shafts over time.

As can be seen in FIGS. 18 and 19, a main shaft 105 may be coupled to a set of planetary gears 63 by going through a bearing and a seal fixed in the second covering 188, and through a third covering 69 and a seal 110 positioned between the second covering 188 and the third covering 69. The seal 110 may be positioned in its place to ensure that compressible fluid flowing into the first housing 74 and the second housing 98 does not leave the system through gaps between the second covering 188 and the third covering 69. The main shaft 105 may also pass through a primary filter 73, an oil seal, and a tapered roller bearing 72 positioned in the bearing chamber 96. A tapered roller bearing 106 and an oil seal may be placed in the first covering 97 and the first covering 97 may be coupled to the bearing chamber 96 with a surface seal in between them and held together with bolts 107 while allowing the main shaft 105 pass through the tapered roller bearing 72 and the oil seal in the bearing chamber 96. Once the first covering 97 and the bearing chamber 96 are connected, a protruded part 162 of the main shaft 105 prevents the main shaft 105 from moving in and out of its place. The bearing chamber may also have an oil inlet 108 and an oil outlet 104. The primary filter 73 may be connected to the first housing 74 and held together with bolts 75. The primary filter prevents materials heavier that air from entering the first housing 74. A fan rotor with fan vans 186 may be mounted on the main shaft 105. The fan rotor may be seated on the main shaft splines to restrict unwanted movement of the fan rotor. The fan rotor may be held in place with bolts. A spinning rear cone 149 may be connected to the fan rotor with bolts 150.

The drive block valve 46 and a valve retainer 80 may be coupled and positioned between the nozzle 76 and the fifth housing 48 and held together with bolts 45. The fifth housing 48 provides an edge where the valve retainer 8 seats and also restricts its movements. The nozzle 76 has an edge that supports the drive block valve 86 and keeps the drive block valve 46 and the valve retainer 80 in fixed position when connected to the fifth housing 48 with bolts 45. The drive block valve 46 provides housing 79 for a roller bearing. The drive block valve 46 has inlet/outlet passages. The outlet passage of the drive block valve 46 has an opening that went all through the drive block valve 46 whereas the inlet passage opening went through half way and has a port, inlet 147, through which compressible fluid may flow into the drive block valve 46. A set of seals 81 and 82/43 (insertable seals) may seat in the valve retainer 80. The drive block 77 seats in the set of insertable seals 81 and 82/43.

The drive block 77 seated in the insertable seals 81 and 82/43 may be coupled to a drive block retainer 85 and held in place with bolts 84. Some lubricant from the primary compressor 1 may flow into the drive block 77 through inlet 44 to lubricate drive block pistons 40 by passing through cavities created on the contact surfaces between the drive block 77 and drive block retainer 85. The drive block pistons 40 are designed so that lubricant may pass through them to lubricate the contacts between the drive block pistons 40 and the swash plate 52 and then to fill the multiplier. In other words, the drive block pistons 40 are hollowed so that lubricant from the drive block 77 goes through them and discharges into the multiplier.

The driven block pistons 54 may be placed on their track and a swash plate retainer 86 may be coupled to the swash plate 52 with bolts to keep the driven block piston 54 heads on their track. The driven block piston 54 heads have a ball like shapes with the sides cut to allow easy coupling and free movement on their tracks. The other end part of the driven block pistons 54 with their rings in them may be inserted into both driven block retainer 55 and driven block 57. The driven block retainer 55 may be connected to the driven block 57 and held together with bolts 47. The driven block 57 may be connected to a set of insertable seals. The set of insertable seals may be seated in a valve retainer 58. The connections of the insertable seals to the driven block 57 and the valve retainer 58 is analogous to the coupling described in connection with the drive block 77 and the valve retainer 80. The valve retainer 58 may be coupled to a driven block valve 60 with bolts 67. A roller bearing may be mounted in an element 89. The valve retainer 58 may be positioned between fourth housing 61 and fifth housing 48 and held together with bolts 87 so that the valve retainer 58 maintains a fixed position.

The driven block valve 60 has an oil inlet through which lubricant may flow through and head for the driven block 57. The flow of lubricant from oil inlet 88 into the multiplier is analogous to that described in connection with the flow of lubricant from oil inlet 44 to the multiplier. Compressible fluid may be drawn into the driven block 57 by driven block pistons 54 through the inlet passage of drive block valve and valve retainer, and be discharged through outlet 160. The driven block 57 may have a shaft 68 that is attached to it, that may be coupled to a planetary gear gearbox 63, connected to increase the speed of the main shaft 105. The driven block shaft 68 may go through a bearing in an element 89, a seal, and a roller bearing seated in the fourth covering 90.

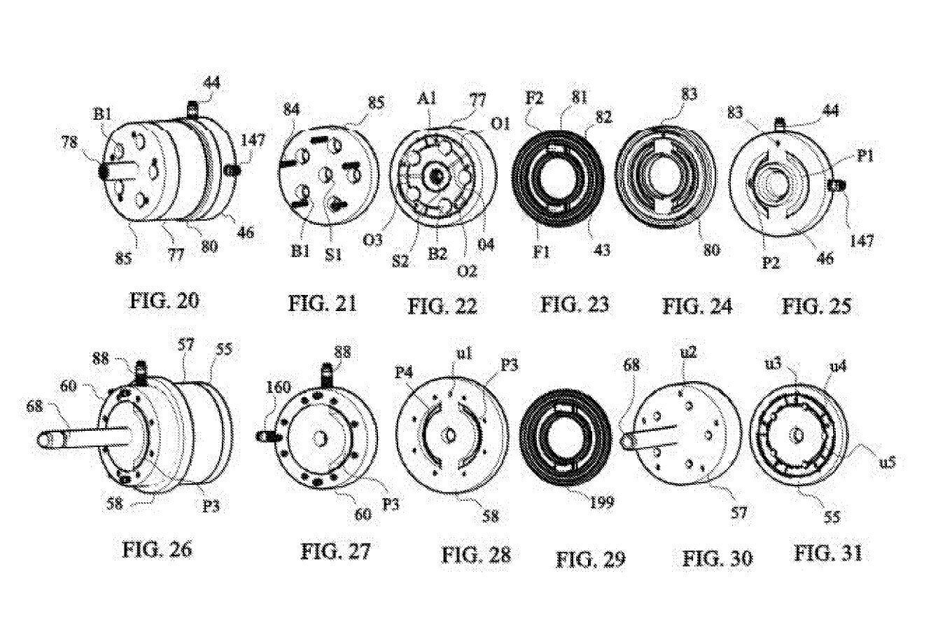

As can be seen in FIG. 20, a view is provided showing the order of arrangement of the first primary shaft 78, the drive block retainer 85, the drive block 77, the set of insertable seals, the valve retainer 80, and the drive block valve 46. The drive block pistons are inserted into piston chamber B1. The drive block valve 46 receives lubricant into the multiplier through valve 44 and compressible fluid through valve 147.

As can be seen in FIGS. 21 and 22, the primary shaft 78 passes through an opening 51 and splines with the drive block 77 at point S2 and the drive block pistons 40 seat in piston chambers B2. The drive block retainer 85 is disconnected from the drive block 46 to provide a view of cavities for lubricant circulation through the drive block 77 and drive block retainer 85. The lubricant from the drive block valve 46 may flow through an oil passage 83 of the drive block valve 46 and the valve retainer 80 as shown in FIGS. 23-25. The insertable seals 81 and 82 provide a space for lubricant to flow through from the valve retainer 80 to the drive block 77 and then be delivered to the drive block pistons 40 by flowing through cavities O1, O2, and O3. The lubricant further flows through cavity O4 to lubricate the roller bearing mounted in housing 79. The bolts 84 that hold the drive block retainer 85 to the drive block 77 engage with the drive block 77 at points A1. Insertable seals 82 and 43 are two in one seals connected to each other with sealing parts F1 and F2. The sealing parts F1 and F2 ensure a sealing between the inlet passage P1 and the outlet passage P2.

In some embodiments, as depicted in FIGS. 26-31, the arrangement of the driven block valve 60, the valve retainer 58, a set of insertable seals 199 is analogous to that described in FIG. 23. The driven block 57, and the driven block valve 60 are arranged in such a way that compressible fluid from inlet valve 146 enters the driven block 57 by flowing through an air inlet passage P3 of the driven block valve 60 and P3 of the valve retainer 58 and exits the multiplier through P4 and outlet valve 160 to head for the speed regulator 167. Some lubricant may be received into the driven block from inlet valve 88, oil passages U1, and U2, and then lubricate the driven block pistons 54 by flowing through cavities U3, U4, and U5. The lubricant may flow through the driven block pistons 54 and be discharged in the multiplier through holes on the driven block pistons 54 heads that are in contact with piston tracks of the swash plate 52 and swash plate retainer 86.

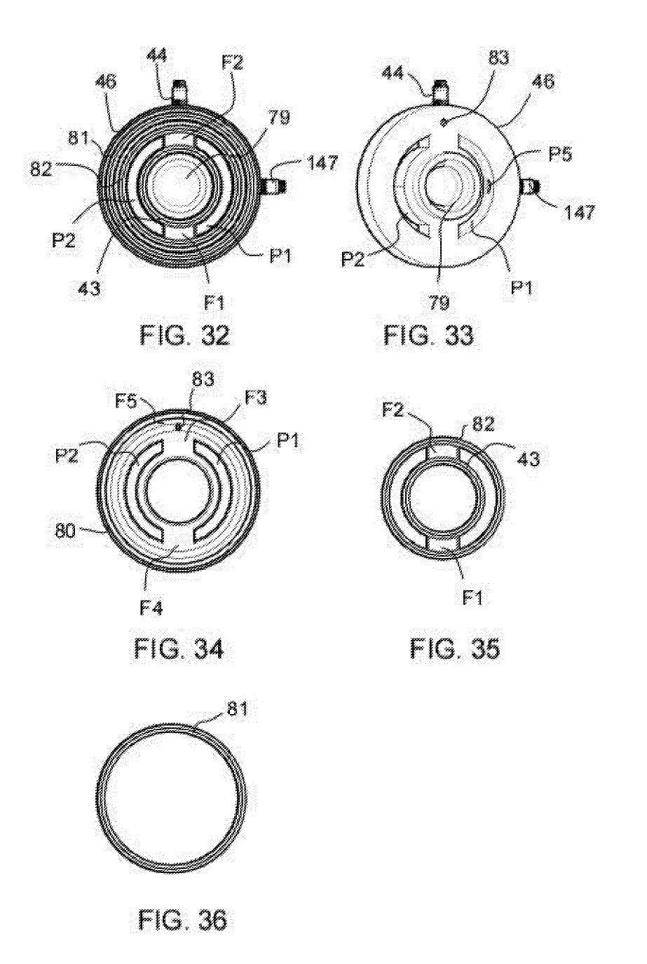

FIG. 32 provides a front view of the drive block valve 46, valve retainer 80, and the set of insertable seals, 81, 82, and 43. FIGS. 33-36 are a view of individual components of FIG. 32. The compressible fluid that enters the drive block 77 flows through inlet valve 147 and port P5, and then, through inlet passage P1. The insertable seal 81 seats in the valve retainer 80 at F5 and seal 82/43 when inserted into the valve retainer 80 seats in the valve retainer 80 so that the seal part F2 is positioned at point F3 and the seal part F1 is positioned at point F4. The valve retainer 80 provides protruded edges so when the insertable seals 81, 82/43 are inserted into the valve retainer 80 they seal properly.

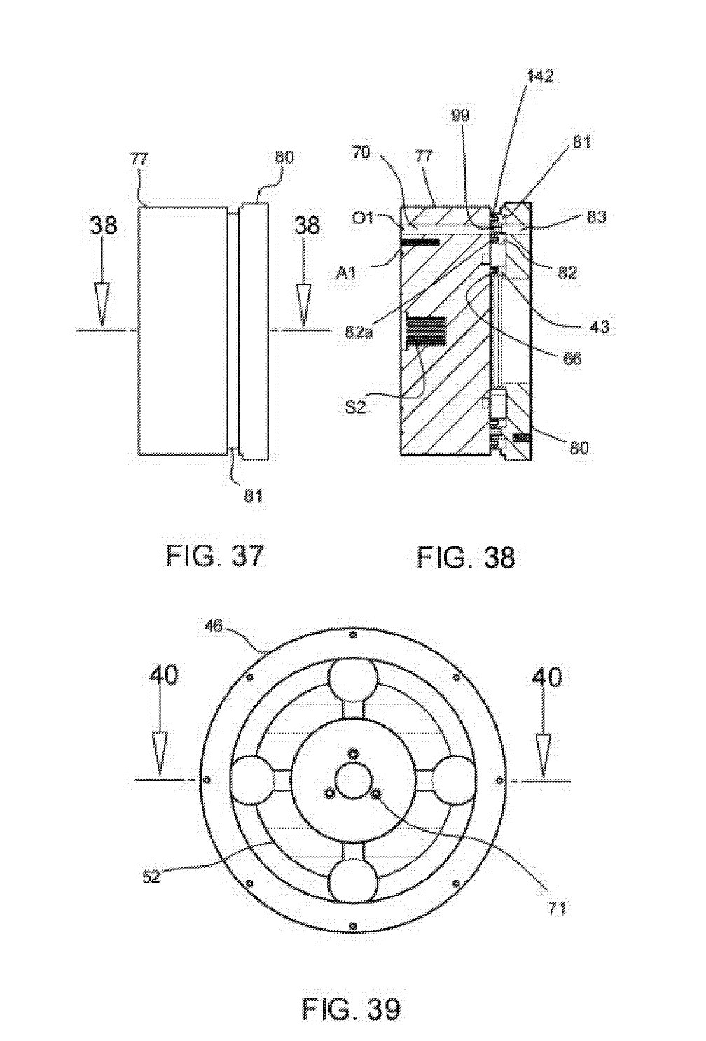

As can be seen in FIGS. 37 and 38, the drive block 77 has extended parts 142, 99, 82a, and 66 that may be inserted into insertable seals 81 and 82/43. The part 99 is a bearer. It rotates on the surface of valve retainer 80 and prevents the drive block 77 from moving beyond its limit toward the valve retainer 80 and also helps the extended parts 142, 82a, and 66 maintain their limits in their seals. Accordingly, the insertable seals 81 and 82 provide a sealing that allows lubricant (oil) to travel from drive block valve 46 and oil passage 83 toward the drive block 77 and also provide lubrication for the bearer 99 as it rotates on the surface of valve retainer 80. The insertable seal 82/43 allows compressible fluid flowing into the inlet passage P1 through inlet 147 to enter the drive block 77 and be ejected toward the outlet passage P2. For example, when compressible fluid that is under pressure enters the drive block valve 46, it flows through the inlet passage P1 toward the drive block 77. The compressed fluid pushes drive block pistons 40 outward. They come in contact with an inclined surface of a swash plate 52 that causes them to slide around on the surface of the swash plate 52. When fluid enters the drive block 77 through the inlet passage, it causes the pistons to slide around the inclined surface of the swash plate 52 in an upward direction. As the pistons slide around in an upward direction, each of them, one after the other reaches its peak where the fluid passage of the drive block 77 is sealed up by the seal part F2. Once it passes the seal part F2, compressed fluid in the drive block 77 is then discharged to the surrounding through the outlet passage P2 of the valve retainer 80 and the drive block valve 46.

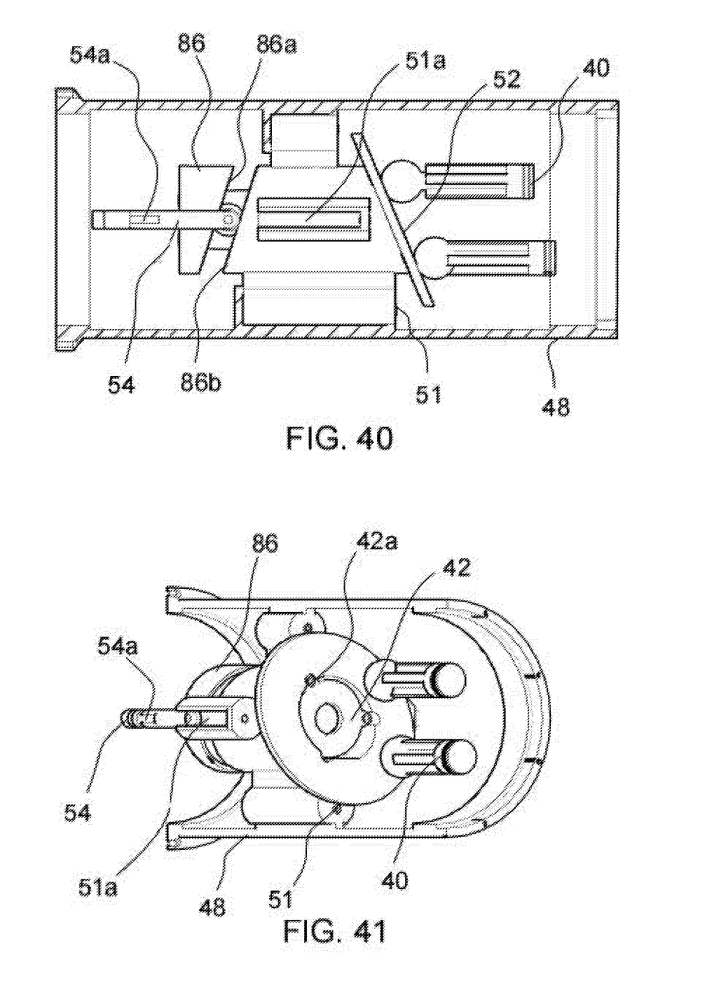

FIG. 39 shows the front view of the swash plate 52 mounted in the fifth housing 48 and the swash plate retainer 86 held to the swash plate 52 with bolts 71. FIGS. 40 and 41 depict the swash plate 52, the fifth housing 48; the swash plate retainer 86, the drive block pistons 40, and the driven block pistons 54 as they are connected to one another. The swash plate 52 has openings 51a in which one or more internally protruded parts of the fifth housing 48 are slotted into the swash plate 52 and held in place with bolts 51. Lubricant from the driven block 57 may enter the driven block pistons 54 through oil openings 54a, openings in the center of the driven block pistons 54, and leaves the driven block pistons 54 from their spherical shape heads to lubricate the piston tracks 86a and 86b. As can be seen in FIG. 41, one or more bolts 42a may lock the M-bearing chamber 42 to the swash plate 52.

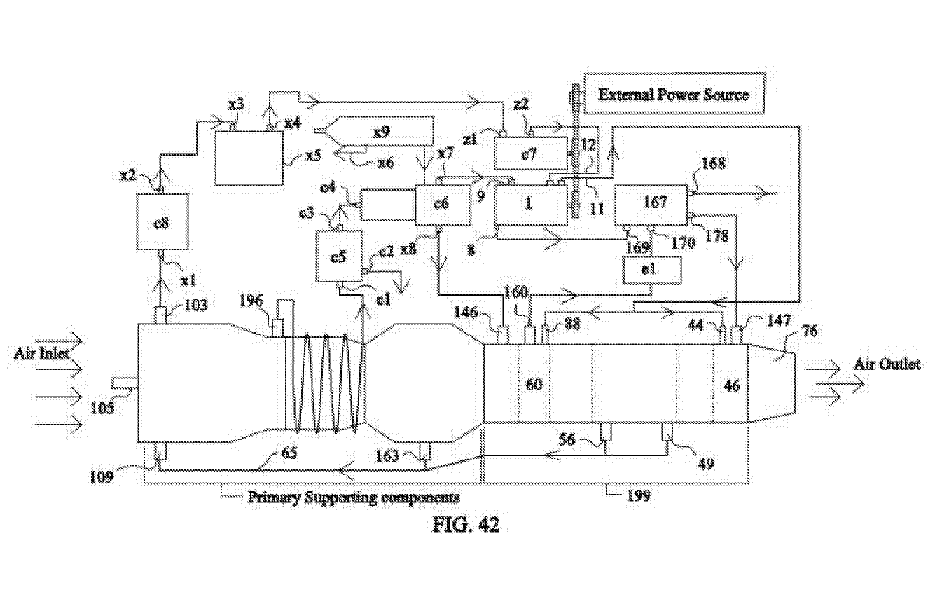

When the multi-hybrid aircraft engine is in operation as shown in FIG. 42, an external power source may drive the primary compressor 1, causing compressible fluid to enter the primary compressor 1 from an outlet x7 of an air chamber through inlet 9 of the primary compressor 1 and then expel the fluid through the primary compressor outlet 8 toward the speed regulator inlet 169. The fluid entering the primary compressor 1 may be drawn from the surrounding through an air inlet. In some embodiments, fluid going through the inlet passes through a primary filter 73, an outlet 196, a coalescer inlet c1, and then to the air chamber c6 from coalescer outlet c3 through inlet c4 a non-return valve of a filter coupled to the air chamber c6. In some embodiments, compressed air from a compressed air tank x9 may be allowed to flow into the air chamber c6 or through an airline x6 to the speed regulator 167 through inlet 169 to directly drive the drive block 77. The above mentioned components are there to ensure that the rate of contaminants entering the air chamber is reduced to the minimum. Fluid flowing in through the air inlet is first processed by the primary filter 73; it leaves the primary filter 73 through air outlet 196 and enters the coalescer c5 where water is separated from compressible fluid that discharges to the air chamber c6. The water separated by the coalescer c5 may be expelled to the surrounding through c2 by an automated drainer. When the multi-hybrid aircraft engine is in operation, the control valve 176 of the speed regulator 167 may be opened, allowing compressible fluid to enter the drive block valve 46 from outlet 178 through inlet 147. The compressible fluid entering the drive block valve 46 may exit to the surrounding as it drives the drive block 77. The rotation of the drive block 77 may be transmitted to the driven block 57 through the primary shafts 78 and 41 that are coupled to the drive block 46 and the driven block 57. The rotation of the driven block 57 causes compressible fluid to enter the driven block 57 from x8 of the air chamber c6 through inlet 146 and then be pumped toward the speed regulator 167 from driven block valve outlet 160 through inlet 170 of the speed regulator 167. The compressible fluid entering the speed regulator 167 through inlet 170 passes through a cooling system e1 where the temperature of the fluid may be dropped. The compressible fluid from the driven block 57 may merge with the compressible fluid from the primary compressor 1 thus, increasing the flow of compressible fluid toward the drive block 46. The increase of flow of compressible fluid toward the drive block 46 may continue as long as fluid flow from the primary compressor 1 to the speed regulator is maintained.

The entire system of the multi-hybrid aircraft engine may be lubricated with lubricant which may be circulated by an oil pump c7. In some embodiments, the lubricant may be introduced to the oil reservoir x5. An external power source may drive the oil pump c7. Lubricant from the oil reservoir x5 may enter the oil pump c7 from outlet x4 through inlet z1 and then may be pumped to the primary compressor from outlet z2 through primary compressor oil inlet 12. In the case where lubricant is introduced to the primary compressor 1 the first time, air in the primary compressor may leave the primary compressor through the primary compressor oil outlet 11 until the desired space within is filled up. When filled, lubricant leaving the primary compressor may enter the multiplier 199 through inlets 44 and 88. In some embodiments, lubricant may pass through the drive block 77 and the driven block 57 to fill up the space within the multiplier 199 where the swash plate and the pistons interact. Lubricant may enter the gearbox and the bearing chamber from outlets 49 and 56 through gearbox inlet/outlet 163 and bearing chamber inlet 109, outlets 49 and 56, gearbox inlet/outlet 163 and inlet 109 are in fluid communication; in other words, pipe 65 links the lubricant to each inlets and outlets. In some embodiments, fluid leaving the bearing chamber may pass through outlet 103, a connector 102 and a pipe 101 to a cooling system c8 through x1 and to an oil filter from outlet x2 through inlet x3 before returning back to the oil reservoir x5. The volume of oil in the multiplier 199, the gearbox, and the bearing chamber may depend on how far the bearing chamber outlet 103 pipe stretches down inside the bearing chamber 96. In some embodiments, oil in the multiplier 199, the gearbox 63, the bearing chamber 96 and oil reservoir x5 may be drained by detaching bearing chamber inlet 109 while the oil pump c7 may be running.

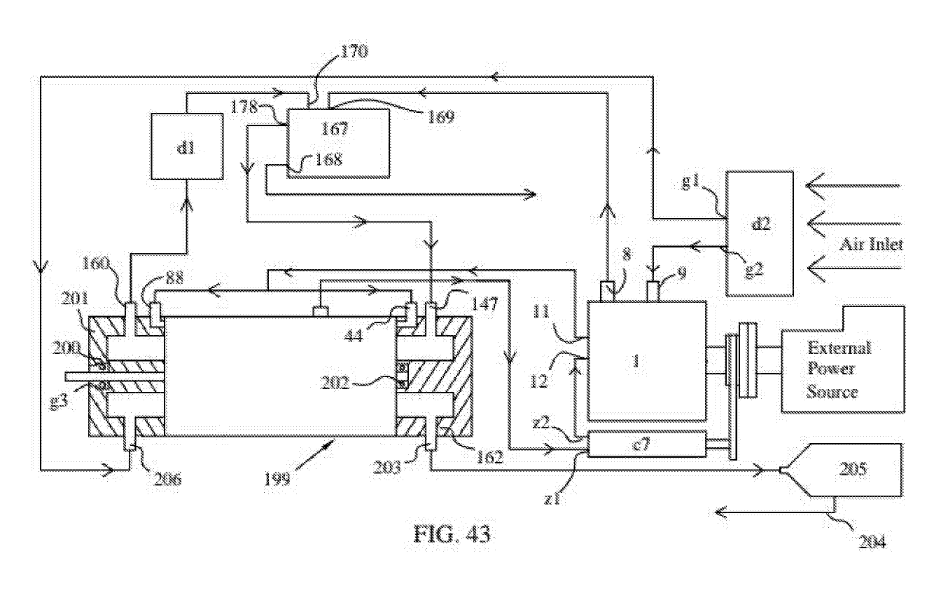

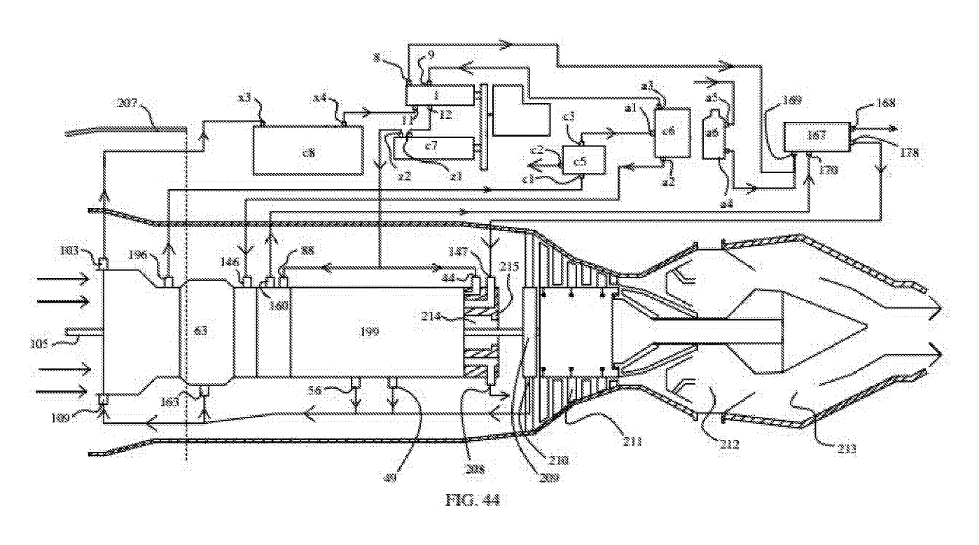

According to another aspect of the multi-hybrid aircraft engine, a hydraulic axial piston compressor for compressing air is provided as can be seen in FIG. 43. A few changes will be made on the driven block valve 60 with present labelling 201, and the drive block valve 46 with present labelling 162. An inlet 206 is now positioned on the driven block valve 201 so that one end of the driven block inlet passage is closed. Similar to the driven block valve 201, the drive block valve 162 has one end of the outlet passage P2 closed so that an outlet 203 is created for directing compressed air through a pipe to a compressed air tank 205. The multiplier housing (fifth housing 48) in this embodiment has an oil drain and an outlet for lubricant to pass through to head for the oil pump c7.

The primary compressor 1 may be driven by any suitable power source. Compressible fluid may be drawn from the surrounding to the primary compressor 1 from an outlet g2 of a filter d2 through inlet 9. The primary compressor 1 may pump the compressible fluid toward the speed regulator 167 from valve 8 through inlet 169. Some compressible fluid may be discharged to drive block valve 162 from outlet 178 through inlet 147. At higher pressure, some compressible fluid entering the speed regulator 167 may leave the speed regulator through outlet 168 to the surrounding. The compressible fluid entering the drive block valve 162 through inlet 147 may drive the drive block 77 and leave the drive block valve 162 through outlet 203. The drive block valve 162 provides housing for a ball bearing 202 to seat in to support the primary shaft. The fluid leaving the drive block valve outlet 203 may be directed to an engine to increase the air intake of the engine or to a compressed air tank 205. The drive block 77 may drive primary shafts 78 and 41 coupled to it.

The primary shafts 78 and 41 may drive a driven block 57 that may drive driven block pistons 54 that may cause compressible fluid to enter the driven block valve 201 from outlet g1 of the filter d2 through inlet 206. The driven block valve 201 has an element for a bearing 200 and a seal g3. The compressible fluid entering the driven block valve 201 may be collected by the driven block pistons 54 and be ejected to the speed regulator 167 from outlet 160 through inlet 170. The fluid entering the speed regulator 167 through inlet 170 may pass through a cooling system d1 so that the temperature of the fluid may be lowered. The compressible fluid entering the speed regulator 167 from inlet 169 and inlet 170 may merge, thereby, resulting in an increase of compressible fluid flow rate. This increases the rotation of the drive block 77 and the primary shafts 78 and 41 which in turn increase the rotational speed of the driven block 57 and fluid flow from the driven block 57 to the speed regulator 167. Insofar as the primary compressor 1 is driven by an external power source, the speed of the output shaft of the driven block 57 will increase and the rate of air flow from outlet 203 to the engine or compressed air tank 205 will increase over time. In the case where the air from outlet 203 is directed to the engine it may pass through a cooling system and a relief valve. The relief valve may be set to allow enough air that permits combustion and cleaner burning of fuel as the engine may be set to maintain a steady speed throughout operation time. In some embodiments, compressible fluid leaving the drive block valve 46 through outlet 203 may be compressed into a compressed air tank 205. The compressed air in the compressed air tank 205 may be allowed into the speed regulator 167 from outlet 204 through inlet 169 to drive the drive block 77.

The entire system of the hydraulic axial piston compressor of FIG. 43 may be lubricated in this fashion; an oil pump c7 driven by an external power source may cause lubricant to be drawn from an oil reservoir disposed with the main body of the multiplier 199 to the oil pump through z1. The lubricant may leave the oil pump to the primary compressor 1 from outlet z2 through inlet 12 and may be pumped back to the multiplier 199 from outlet 11 through inlet 44 and 88. In some embodiments, the lubricant leaving the oil reservoir may pass through a cooling system and a filter before it is received by the oil pump c7.

In accordance with another aspect of the multi-hybrid aircraft engine, as depicted in FIG. 44, an integration of any suitable turbo engines (jet engine) may be made, allowing for functionality of the multi-hybrid aircraft engine as a jet engine powered by compressed air, an external power source, and/or jet fuel. In some embodiments, special attention may be given to turbojet engines, turbofan engines, and/or turboprop engines as engines with potentials to be integrated. A few changes on some components of multi-hybrid aircraft engine and of turbo engine may be made and a detailed description given hereafter. However, like features of multi-hybrid aircraft engine of FIG. 44 are designated with like reference numerals described above, therefore, relevant disclosure set forth above regarding similarly identified features may not be repeated hereafter. Moreover, specific features of multi-hybrid aircraft engine and related components shown in other figures may not be shown or identified by a reference numeral in the drawings or specifically discussed in the written description associated with FIG. 44. However, such features may clearly be the same as features showed in other embodiments and/or described with respect to such embodiments.

The phrase “turbo engine” is broad enough to refer to any suitable jet engine (e.g., turbojet engine, turbofan engine, turboprop engine, and/or any other suitable known jet engine).

As can be seen in FIG. 44, the drive block valve 215 has an element 214 for a bearing and a seal to seat in and an opening for a shaft to go through to drive set of planetary gears in a gearbox 209 for increasing the speed of a compressor 211. The shaft that drives the compressor may be an extended part of drive block 77 as in the case of driven block 57. The drive block shaft may drive a set of planetary gears in the gearbox 209 and the set of planetary gears in the gearbox 209 may drive the compressor 211. Any suitable combustion chambers 212 may be used for combusting compressed air from the compressor 211 and the afterburner exhaust 213 may be used for thrust increment. The combustion chamber 212 may serve for the purpose of ignition so that compressed air from the compressor 211 that bypasses the combustion chamber 212 mixes with fuel sprayed to produce an afterburner condition. In some embodiments, a turbine may not be needed therefore; higher compression and fuel ejection to the combustion chambers 212 and afterburner exhaust 213 may only result in a higher generation of thrust. In some embodiments, the drive block valve 215 provides an outlet valve 208 for compressing air into compressed air tank a6. The compressed air in the compressed air tank a6 serves as a power source for the multi-hybrid aircraft engine of FIG. 44.

To run the multi-hybrid aircraft engine of FIG. 44, an external power source may drive the primary compressor 1. Compressible fluid (air) may enter the primary compressor 1 from an air chamber c6 from outlet a3 to the primary compressor 1 through inlet 9. The compressible fluid may enter the air chamber c6 by flow through outlet 196 to a coalescer c5 through c1 and then to the air chamber c6 from outlet c3 through inlet a1 a non-return valve. Contaminants may leave the coalescer c5 through outlet c2.

The primary compressor 1 may pump compressible fluid to a speed regulator 167 from outlet 8 through inlet 169 where the pressure of the compressed fluid may be controlled. The compressible fluid entering the speed regulator 167 from primary compressor 1 may be directed to a drive block valve 215 where it may drive a drive block 77 and be discharged to the compressed air tank a6 through a5. In some embodiments, upon full compression of the compressed air tank a6, a relief valve may open a valve that allows compressed fluid from outlet 208 to discharge to the surrounding. The driven drive block 77 may drive a driven block 57 coupled to primary shafts 78 and 41. The rotation of the driven block 57 may cause driven block pistons 54 to collect compressible fluid from the air chamber c6 from outlet a2 through inlet 146 and pump the compressible fluid to the speed regulator 167 from outlet 160 through inlet 170. In the speed regulator, compressible fluid from the driven block 57 combines with the compressed air from the primary compressor 1 and heads for the drive block 77. The merging of compressible fluid results in an increased flow rate of compressible fluid through the drive block 77. This in turn increases the rotational speed of the primary shafts 78 and 41 that are coupled to drive block 77 and driven block 57. The increase of speed of the driven block 57 causes more compressible fluid from the driven block 57 to be discharged to the speed regulator 167 which results to more flow of compressible fluid through the drive block 77. The increase of rotational speed of drive block 77 and the output shafts may continue over time provided that the primary compressor 1 is continuously driven by the external power source. In some embodiments, when the external power source is shut down, compressed air from the compressed air tank a6 may drive the drive block 77 by flowing through the speed regulator 167 from outlet a4 through inlet 169 and 178 and then through inlet 147 of the drive block valve 215.

Lubricant may be circulated throughout the system by traveling from the oil pump c7 driven by an external power source. The lubricant may be received from a reservoir c8 to the oil pump c7 from outlet x4 through inlet 11, outlet 12, and inlet z1 and then from outlet z2 of the oil pump c7 to the multiplier 199 through inlets 44 and 88. The lubricant may leave the multiplier 199 through outlets 49 and 56, and may head for the gearbox inlets 210 and 163, and the bearing chamber 96 through inlet 109. The lubricant may leave the bearing chamber 96 to the reservoir c8 from outlet 103 through inlet x3. In some embodiments, the lubricant may pass through a cooling system and an oil filter before entering the reservoir c8.

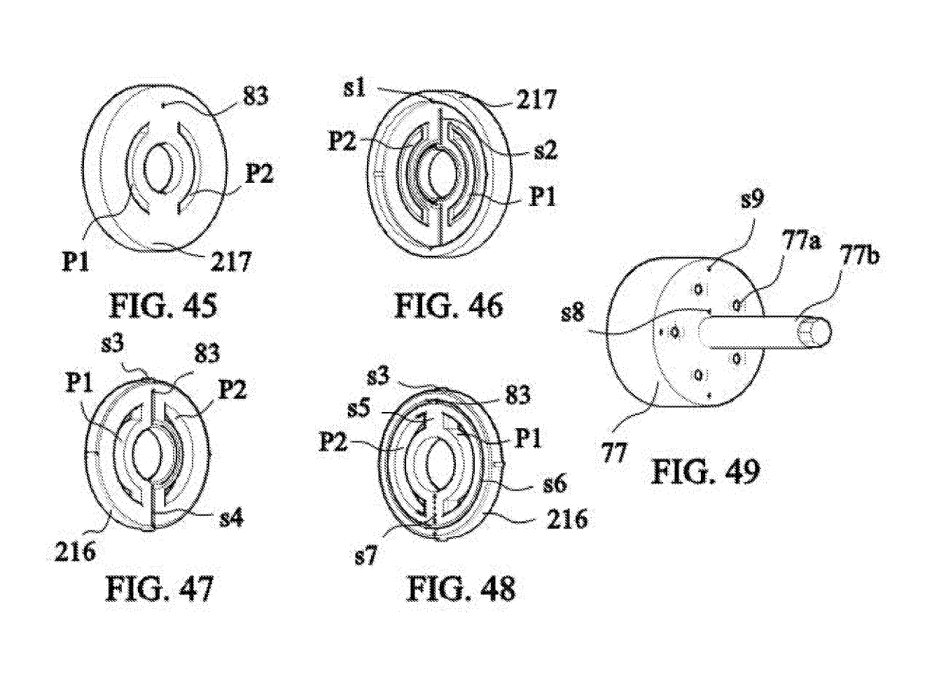

Accordingly, a multi-hybrid aircraft engine is provided with a sealing system that allows for the flow of lubricant through a flat surface seal 216 to contact surfaces between the flat surface seal 216 and the drive block 77 as shown in FIGS. 45-49. In some embodiments, the introduction of fluid between the contact surfaces of the flat surface seal 216 and the drive block 77 is to reduce heat generation due to friction and promote higher rpm of the multiplier 199.

As can be seen in FIGS. 45-49, a valve retainer 217 and a flat surface seal 216 may have a common oil passage 83 for lubricant to pass through from drive block valve 46 to drive block 77. Some lubricant flowing through the oil passage 83 of the valve retainer 217 may fill an enclosed cavity formed when the flat surface seal 216 is mounted in the valve retainer 217. FIG. 45 shows the back side of the valve retainer 217 and the oil passage 83 through which lubricant flows from the drive block valve 46 to the drive block 77. FIG. 56, a prospective view, reviews the front side of the valve retainer 217 and the cavity s2 on the valve retainer 217. As can be seen in FIG. 47, on the back side of the flat surface seal 216 is a cavity s4 that forms an enclosure with the cavity s2 on the front side of valve retainer 217 when the flat surface seal 216 is mounted in the valve retainer 217. The lubricant that flows through the enclosed cavity between the flat surface seal 216 and the valve retainer 217 passes through one or more holes s7, as can been seen in FIG. 48, to lubricate the contact surface of the drive block 77 with the flat surface seal 216. The narrow holes s7 are created at the down side of the flat surface seal 216 because pressure at that point is lower than any other point. The drive block 77 inlets/outlets 77a are small enough to fit between the holes s7 and the inlet passage P1 or the outlet passage P2. This prevents compressed fluid from leaving the outlet passage P2 or inlet passage P1 through the holes s7. Some lubricant passes through oil passage 83 of the flat surface seal 216 and surfaces on the front cavity s6 of the flat surface seal 216 to enter the drive block 77 through holes s9. When the flat surface seal 216 is mounted or inserted into the valve retainer 217, one or more locks s3 seat in one or more lock openings s1 to keep the seal in a fixed position. The valve retainer 217 may have protruded edges around the inlet passage P1, outlet passage P2, and the central opening that provide a sealing between the valve retainer 217 and the flat surface seal 216. The lubricant flowing through the drive block 77 may lubricate the drive block pistons 40 and some of the lubricant may pass through a hole s8 to lubricate a bearing seated in an element 79 of the drive block valve 46. A point s5 provides a sealing as the piston inlet/outlet 77a move away from inlet passage P1 to outlet passage P2. An output shaft 77b may be used for driving a device.

The sealing system described above may be used to seal the driven block 57 and the valve retainer 58. This type of sealing may permit the escape of lubricant through the outlet passage P2 therefore; the outlet hose/pipe may be connected to a coalescer to separate air from lubricant and to return lubricant back to the oil reservoir.

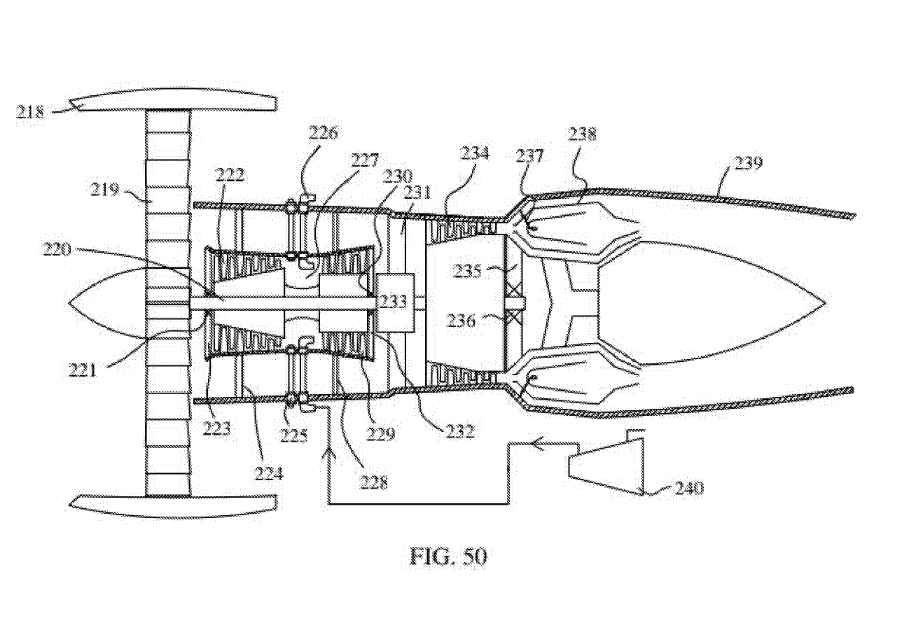

Furthermore, another aspect of the multi-hybrid aircraft engine herein referred to as a multi-hybrid turbojet engine is provided comprising a primary compressor (an axial or a centrifugal compressor), a secondary compressor, a combustion compressor, an output shaft, and at least one turbine. The embodiment, as can be seen in FIG. 50, is a configuration of turbojet engines in which the working principle is within the scope of the embodiments previously disclosed. The present disclosure as is set forth hereafter is intended to show how turbojet engines can be configured using the working principle of previous disclosure therefore, detailed description would only be given to those components of turbojet engines necessary for understanding the disclosure of the present embodiments.

As can be seen in FIG. 50, an external power source may drive the primary compressor 240 causing it to compress air to a compression chamber 227 through a compression nozzle 226. The compressed air in the compression chamber 227 may drive a turbine 229. The turbine 229 may be connected to an output shaft 220 that is connected to a secondary compressor 222, a front fan 219 protected with a fan case 218, set of planetary gears in a gear chamber 233, and a combustion compressor 234. This configuration allows the turbine 229 to drive the output shaft 220, the secondary compressor 222, the front fan 219, the set of planetary gears in the gear chamber 233, and the combustion compressor 234 thus, when the turbine 229 is driven by the compressed air from the primary compressor 240, the output shaft 220 that is in connection with it drives the secondary compressor 222, causing compressed air through the compression chamber 227. This results to an increase of compressed air through the compression chamber 227. This increased of compressed air increases the flow of the compressed air through the turbine 229 thus, an increase of rotational speed of the turbine 229. The rotational speed of the turbine 229 may be controlled by regulating the rate of compressed air flow through relief valves 225. The relief valves 225 work the same way an aircraft relief valves work. The more the relief valves 225 are opened the more the compressed air in the compression chamber 227 escapes through them. The compression chamber 227 of the multi-hybrid turbojet engine may be thought of as combustion chambers of conventional turbojet engines and the compression nozzle 226 may be thought of as the fuel nozzle used in conventional turbojet engines.

It should be known that the secondary compressor 222 is a high pressure compressor and the turbine 229 is a high pressure turbine. However, the combustion compressor 234 is a higher pressure compressor. This type of configuration ensures cleaner combustion as the combustion is cleaner and efficient when the combustion compressor produces higher compression. However, the compression that drives the front fan 219 allows the engine to operate at higher efficiency as the front fan 219 reduces drag when running at subsonic speeds.

In some embodiments, the output shaft 220 seats in a plurality of bearings 221, 230, and 236. The front bearing 221 seats in a front bearing support 223, the center bearing 230 seats in a center bearing support 232, and the rear bearing 236 seats in a rear bearing support 235. The front bearing support 223 and the center bearing support 232 are connected to an inner casing that is supported with casing supports 224 and 228. The gear chamber 233 has a support 231 attached to an outer casing. In some embodiments, the multi-hybrid turbojet engine is equipped with an afterburner exhaust 239 for combustion of compressed air that bypasses the combustion chamber 238. One of the purposes of the combustion chamber 238 is to ignite jet fuel injected into the combustion chamber 238 through one or more fuel nozzles 237.

The multi-hybrid turbojet engine may be powered by one or more external power sources at the same time. For example, an electric motor and/or an internal combustion engine may run the primary compressor 240 so that the primary compressor 240 serves as the main power source while the thrust produced by combusting compressed air and jet fuel in the combustion chamber 238 and afterburner effect are used for take-off and landing. The electric motor may be powered by batteries and/or a combustion engine. In this way, the combustion engine may be engaged to run the electric motor and at the same time charge the batteries, and when the batteries are fully charged the engine may be shut down so that the electric motor is powered by the batteries. In some embodiments, compressed air in a compressed air tank may be allowed to flow directly into the compression chamber 227 to drive the turbine 229. Thus, the multi-hybrid turbojet engine may be powered by one or more external power sources. In some embodiments, compressed air from primary compressor 240 and/or compressed air tank may be directed to compression chambers 227 of one or more multi-hybrid turbojet engines.

One of ordinary skill in the art, with the benefit of this disclosure, will understand that other configurations are also within the scope of this disclosure, such as configurations in which any suitable compressors and turbines/compressor motors may be configured to work as a multiplier or in a multi-hybrid aircraft engine.

Moreover, the multi-hybrid aircraft engine operation method comprises a combination of an internal combustion engine and an electric motor/generator, coupled through the same drive pulley to spin the primary compressor. During take-off and climb, when maximum power is required, the internal combustion engine and motor work together to power the aircraft, but once cruising height is reached, the electric motor may be switched into generator mode to recharge the batteries or used in motor assist mode to minimise fuel consumption. In some cases, compressed air in the compressed air tank may power the multiplier and when at low pressure state, the internal combustion engine and/or electric motor may assume power while the multiplier stores air in the compressed air tank.

It should be appreciated by one skill in the art with the benefit of this disclosure that the multiplier is merely a combination of a compressor and a compressor motor that are mechanically in connection with each other hence, any unit (the compressor or the compressor motor) can be disconnected from the other and be configured to function as a single unit. Accordingly, a unit of the multiplier functioning as a compressor may serve the purpose of a primary compressor of the present disclosure. In addition, the primary compressor may be designed having one or more outlets for permitting the flow of compressed air to the multiplier(s) through the speed regulator(s). Each outlet of the primary compressor may be linked to one or more speed regulators that are linked to one or more multipliers. In this way, a single primary compressor driven by an external power source may drive one or more multipliers. In other words, a single primary compressor may drive one or more multi-hybrid aircraft engines.

Reference throughout this specification to “embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of a single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims. It will be apparent to those having skill in the art that changes may be made to the details of the above-described embodiments without departing from the underlying principles of the present disclosure.

In addition, one of ordinary skill in the art, with the benefit of this disclosure, will understand that a configuration in which the multiplier is rotated in another direction is within the scope of this disclosure. The method of operation however, may require the inflow of compressible fluid from the speed regulator through the outlet of the drive block valve while permitting compressible fluid to flow to the speed regulator through the inlet of the driven block valve.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Furthermore, it should be appreciated by one skilled in the art with the benefit of this disclosure that the configuration and use of the multiplier and the primary compressor is not limited to aircraft application but can as well be used in other applications such as a windmill and a power source for machines/equipment. In other words, the multiplier and the primary compressor may be sued in windmill application. For example, the windmill propeller may drive the primary compressor while the multiplier drives the AC motor. In addition, compressed air from the multiplier may be stored in a compressed air tank for driving the multiplier when there is less wind to propel the windmill propeller that drives the primary compressor. Accordingly, in some embodiments, where the multiplier and the primary compressor are configured for the purpose of compressing air, the driven block shaft and the drive block shaft may not be needed so that the multiplier only has openings (ports) for fastening inlet/outlet valves.

What is claimed is:

1. A multi-hybrid aircraft engine comprising:
a reservoir;
an oil pump;
an air chamber;
a speed regulator configured to regulate the flow of compressible fluid through the speed regulator;
a primary compressor comprising an inlet in fluid communication with the air chamber and an outlet in fluid communication with the speed regulator;
a multiplier comprising plurality of inlets/outlets, a drive block linked to an inlet in fluid communication with the speed regulator and a driven block linked to an outlet in fluid communication with the speed regulator;
primary shafts; and
an output shaft;
wherein the primary compressor is configured to receive compressible fluid from the air chamber through the inlet of the primary compressor and pump the compressible fluid to the drive block through the speed regulator to drive the drive block;
wherein the drive block, when driven by the compressible fluid pumped by the primary compressor, rotates the primary shafts to drive the driven block; and
wherein the driven block is configured to receive non-compressible fluid from the air chamber through the inlet and pump the compressible fluid from the air chamber to the drive block through the speed regulator when the driven block is driven by the primary shafts that are rotated by the drive block.

2. The multi-hybrid aircraft engine of claim 1, further comprising set of planetary gears wherein the set of planetary gears when coupled to the driven block increases the speed of the output shaft.

3. The multi-hybrid aircraft engine of claim 1, wherein the multi-hybrid aircraft engine is configured to transition between one or more states, wherein the one or more states are selected from the group consisting of:
(a) a state in which the multiplier rotates the output shaft in a first direction
(b) a state in which the multiplier rotates the output shaft in a second direction that is different from the first direction; and
(c) a state in which the compressible fluid pumped by the primary compressor bypasses the multiplier.

4. A multi-hybrid turbojet engine comprising;
a primary compressor;
an output shaft;
a compression chamber configured to receive compressed air from the primary compressor;
a secondary compressor configured to compress air toward the compression chamber a turbine configured to be driven by compressed air received by the compression chamber;
a propeller coupled to the output shaft;
a set of planetary gears driven by the output shaft;
a combustion compressor; and
a combustion chamber;
wherein the turbine when driven by the compressed air from the compression chamber drives the output shaft; and
wherein the output shaft when driven by the turbine drives the secondary compressor for compression of air toward the compression chamber.
wherein the combustion compressor is driven by the set of planetary gears for compression of air toward the combustion chamber.

5. The multi-hybrid aircraft engine of claim 1, further comprising primary supporting components, wherein the oil pump pumps lubricant from the reservoir towards the multiplier and the primary supporting components for lubrication.

6. The multi-hybrid aircraft engine of claim 1, further comprising a swash plate configured to provide piston tracks for driven block pistons and drive block pistons wherein the piston tracks for the driven block pistons are formed by mounting a swash plate retainer on the swash plate, wherein an opposite part of the swash plate provides an inclined flat surface for the drive block pistons to roll on.

7. The multiplier of the multi-hybrid aircraft engine of claim 1, wherein the driven block is configured to receive lubricant from the inlet to lubricate the driven block pistons and piston tracks through openings in the driven block pistons.

8. The multiplier of the multi-hybrid aircraft engine of claim 1, further comprising set of insertable seals configured to receive lubricant/compressible fluid through the multiplier inlets and allow then flow toward the drive block, wherein the drive block has protruded parts to be inserted into the set of insertable seals.

9. The multi-hybrid aircraft engine of claim 1, wherein the multiplier uses a flat surface seal for sealing the space between the drive block/driven block and the valve retainers.

10. The multi-hybrid aircraft engine of claim 1, wherein any suitable compressor can serve as the primary compressor.

11. The multi-hybrid aircraft engine of claim 1, wherein the multiplier can be configured to function as two separate units, a compressor and an air motor; wherein the unit can be modified and configured with other components of the multi-hybrid aircraft engine for a complete functioning unit.

12. The multi-hybrid aircraft engine of claim 1, wherein the multiplier is configured by integrating any suitable known compressor and air motor.

13. The multi-hybrid aircraft engine of claim 1, wherein the multiplier and the primary compressor are configured to function as a compressor and/or an air motor.

14. The multi-hybrid aircraft engine of claim 1, wherein the multiplier and the primary compressor are configured to work in other applications such as a windmill, tidal turbine, auto mobiles, and/or machinery; wherein the primary compressor is driven by a power source of the intended application while the multiplier drives the application as well as compresses and uses compressed air.

15. The multi-hybrid aircraft engine of claim 5, further comprising; set of planetary gears, driven by a drive block shaft; a compressor; and one or more combustion chambers linked to an afterburner exhaust,
wherein the driven set of planetary gears drives the compressor to compress air toward the combustion chamber for combustion; and
wherein when the combustion chambers combusts, bypass compressed air flows through the afterburner exhaust to create afterburner effect.

16. The multi-hybrid turbojet engine of claim 4, wherein the primary compressor can be configured to compress air towards one or more compression chambers of multi-hybrid turbojet engine.

17. The multi-hybrid aircraft engine of claim 1, wherein the drive block pistons are larger (e.g., wider in diameter) than the compressor pistons, which are larger than the driven bock pistons.

18. The multi-hybrid aircraft engine of claim 1, wherein the drive block pistons are larger (e.g., wider in diameter) than the driven block pistons, which are larger than the compressor pistons.

19. The multi-hybrid aircraft engine of claim 1, wherein the drive block pistons are larger (e.g., wider in diameter) than both the driven block pistons and the compressor pistons, which are of the same diameter.
